(19) United States
(12) Patent Application Publication
(10) Pub. No.: US 2002/0054990 A1
(43) Pub. Date: May 9, 2002

(54) Plastic system and articles

(76) Inventor: Kenneth Ross Anders, Lapeer, MI (US)

Correspondence Address: Gifford, Krass, Groh, Sprinkle,, Anderson & Citkowski, P.C., Suite 400, 280 N. Old Woodward Avenue, Birmingham, MI, 48009-5394, US

(21) Appl. No.: 09/992,615

(22) Filed: Nov. 6, 2001

Related U.S. Application Data
(62) Division of application No. 09/427,357, filed on Oct. 26, 1999.

(51) Int. Cl. B32B 3/00

(52) U.S. Cl. 428/316.6

(57) ABSTRACT

Improved polyurethane containing systems and articles, and process for making the same.

### TECHNICAL FIELD

The present invention relates generally to molded plastic systems and articles, and more particularly, to improved molded polyurethane systems and articles.

### BACKGROUND ART

Plastic systems, such as molded plastic systems and articles, possess numerous advantages over many previous systems. Ease and flexibility in manufacture and the ability to form complex shaped articles are among the many benefits often cited in favor of plastics, such as molded plastics. One family of molded plastics is the crosslinkable molded plastic. Ordinarily the starting materials are placed in a mold and are activated to react. Upon curing, articles produced thereby often are relatively near net shape and require little additional processing. Systems such as these permit for the manufacture of composite materials or other combination of dissimilar materials.

Until the present invention, however, it has been found that certain materials do not process well to join dissimilar materials by in-situ processing. For instance, materials such as acoustic foams do not bond well to other materials, making efficient in-mold processing of articles extremely difficult using ordinary processing parameters.

It is possible to manage costs and property characteristics in the manufacture of plastic articles by the selection or variation of its constituent ingredients. For example, frequently fillers are employed. Unfortunately, the selection of appropriate fillers may be limited in various instances where such fillers are incompatible with the remaining ingredients.

One popular plastics system has involved the employment of polyurethanes as the main plastic constituent. Polyurethane systems generally are well known in the art and typically involve the reaction of a polyol and a polyisocyanate. Examples of polyurethane systems and their constituent ingredients can be found in without limitation, U.S. Pat. Nos. 5,422,380; 5,417,161; 4,866,102; and 4,714,161; 4,866,102; and 4,714,575 all of which are expressly incorporated by reference.

### SUMMARY OF THE INVENTION

The present invention overcomes the shortcomings of the prior art by providing an improved molded plastic system and articles. In one embodiment, the improved system includes a polyurethane that has been reacted in the presence of a filler that includes particulated by-products from the solids of reclaimed paint sludge.

In another embodiment, the system (with or without the filler) contemplates bonding at least a portion of one surface of a first article with a second article to form a composite or laminate.

The system and articles of the present invention offer improved capability for the manufacture of molded plastic articles and particularly molded polyurethane foam structures. The ability to incorporate reclaimed paint sediment or sludge into the foam offers attractive economic and environmental advantages, and permits for the manufacture of relatively rigid foamed articles, capable of withstanding structural stresses encountered in many construction applications. Likewise, laminate or composite articles made with or without the filler, as disclosed, offer high integrity mating between materials of two articles, particularly when such materials are dissimilar. Though optional, no additional layer of adhesive is needed nor other labor or cost-intensive processing steps.

### DESCRIPTION OF DRAWINGS

FIG. 1 is a schematic of an exemplary apparatus for making one type of article of the present invention.

### DETAILED DESCRIPTION OF PREFERRED EMBODIMENT

Though the system and articles of the present invention are molded plastics, it should be appreciated that the scope is not intended to be limited by the present description of the preferred embodiment. As the skilled artisan will readily appreciate, a host of variations are possible and would still fall within the scope of the invention. Thus, while a polyurethane system is preferred and disclosed, the invention may find suitable application in other plastic families (e.g., without limitation, vinyl esters, expoxies or polyesters), either singly or in combination with a polyurethane. Moreover, processing techniques other than molding may be employed to yield articles in accordance with the present invention. The present disclosure of molding is not intended as limiting.

The present invention generally includes a plastic system that is based on a polyurethane system, a reinforcement material (e.g., glass) and is capable of exhibiting at least the following approximate ranges of properties and characteristics in Table I, when used by itself. An article exhibiting gradients of these properties across a section of the article may also be made in accordance with the present invention. Higher and lower ranges of course may be achieved by variations in the amounts and nature of ingredients.

TABLE I

| | Preferred | More Preferred |
|---|---|---|
| Density: | 5-50 pcf | 15-35 pcf |
| Flexural Modulus: | 15-300 ksi | 50-150 ksi |
| Compressive Strength: | 20-130 ksi | 30-75 ksi |

Preferably the compressive strength is at least about 20 ksi, and more preferably at least about 50 ksi. In some applications it is at least about 70 ksi, and more preferably at least about 100 ksi.

In a more preferred embodiment, the polyurethane is prepared from a reaction of polyisocyanate and polyol starting materials, wherein the polyol includes a noncyclic aliphatic polyactive amine-containing polyol. In another preferred embodiment, the polyurethane includes a filler that includes particulated reclaimed paint sediment by-product. In another preferred embodiment, a first polyurethane article is bonded to a second article, and more preferably forms a laminate structure having two dissimilar materials bonded together over at least a portion of the interface between the articles.

The preferred polyurethane is described in the following by reference to a detailed description of its starting materials, which generally include polyisocyanate and polyol. The preferred starting materials also include a catalyst, a blowing agent, and a reinforcement material, and may further include a filler and one or more ingredients selected from the group consisting of a chain extender, crosslinking agent, flame retardant, surfactant, mold release agent, or a mixture thereof. Other ingredients likewise are possible.

An example of the relative proportions of starting materials (when employed) of a preferred composition of the present invention is set forth in Table II (expressed in approximate parts by weight):

TABLE II

| | |
|---|---|
| Polyisocyanate | .3 to about 5 parts |
| Polyol | .3 to about 5 parts |
| Catalyst | .001 to about 15 parts |
| Blowing Agent | .025 to about 5 parts |
| Reinforcement | 5 to about 80 parts |
| Filler | 5 to about 80 parts |

Table III illustrates another preferred example of relative approximate proportions of starting materials when employed:

TABLE III

| | |
|---|---|
| Polyisocyanate | .4 to 1 parts |
| Polyol | 1 parts |
| Catalyst | 0.002 to 10 parts |
| Blowing Agent | .025 to 1 parts |
| Reinforcement | 15 to 25 parts |
| Filler | 10 to 30 parts |

Combinations of components in the ranges of Tables II and III may also be employed. As the skilled artisan will appreciate the relative amounts can be varied outside of the above disclosed ranges (e.g., filler up to about 80% by weight of the overall product) as desired to achieve property optimization for a given application.

The polyisocyanates used in the invention may be selected from aliphatic, aromatic compounds having two or more isocyanate groups or mixtures thereof. Alternatively, the polyisocyanate may include a cycloaliphatic isocyanate. Combinations of the above polyisocyanates may also be employed. Polyisocyanates also may have more than two isocyanate groups present.

Many commercial polyisocyanates are available. The skilled artisan will appreciate, in the absence of a commercially available polyisocyanate, one may be prepared by reacting an appropriate excess of a diisocyanate with a polyhydric compound. Polyisocyanates may also be prepared by a self-condensation reaction of the isocyanate group, i.e., three isocyanate groups may condense to form an isocyanurate ring. Crude polyisocyantes may also be used.

Suitable aliphatic diisocyanates preferably contain 2 to about 36 carbon atoms (excepting the carbon atom in the isocyanate groups), and include cyclic and non-cyclic aliphatic groups. Examples of difunctional aliphatic polyisocyanates recognized by those skilled in the art include, but are not limited to, ethylene diisocyanate, tetramethylene diisocyanate, hexamethylene diisocyanate (HDI), isomers of cyclohexane diisocyanate including trans-cyclohexane-1,4-diisocyanate (CHDI), 4,4′-methylene-bis(cyclohexylisocyanate) (hydrogenated MDI), dodecamethylene diisocyanate, dimeryl diisocyanate (DDI), isophorone diisocyanate (IPDI), 2,2,4-trimethylhexamethylene-1,6-diisocyanate, isomers of tetramethylxylene diisocyanate (e.g. benzene,1,3-bis (1-isocyanato-1-methylethyl)- or benzene, 1,4-bis( 1 -isocyanate- 1 -methylethyl)and mixtures thereof.

Examples of familiar suitable aromatic diisocyanates are those that generally contain from about 6 to about 25 carbon atoms (excepting the carbon atoms in the isocyanate groups). Specific examples of representative difunctional aromatic polyisocyanates include, but are not limited to, isomers of toluene diisocyanate (TDI) (e.g., toluene-2,4-diisocyanate, toluene-2,6-diisocyanate), isomers of tetramethyl-xylene diisocyanate (TMXDI) (e.g., the meta and para isomers), isomers of phenylene diisocyanates (e.g., meta and para (PPDI) isomers, 4,4′-methylene-bis(phenylisocyanate) (also known as diphenylmethane-4,4′-diisocyanate (4,4′-MDI or as MDI), diphenylmethane-2,4-diisocyanate (2,4′-MDI), naphthalene-1,5-diisocyanate (NDI)), isomers of diethylbenzene diisocyanates, and mixtures thereof.

Of course, further included among the isocyanates useful in this invention are the dimers and trimers of isocyanates and diisocyanates and polymeric diisocyanates such as those having the general formula:

[R(NCO)ₓ]_{y}

in which x and y are each integers of two or more, and R is a polyfunctional organic radical, and/or, as additional components in the mixtures, compounds of the general formula:

R(NCO)ᵢ

in which is one or more and R is a monofunctional or polyfunctional atom or radical.

The skilled artisan will appreciate, depending upon the isocyanate used, the relative amounts of the isocyanate can be varied to increase or decrease the hardness of the foam.

In a highly preferred embodiment, the polyisocyanate is an aromatic diisocyante, and more preferably it is the well-known MDI.

### Polyol

The polyol reactants employed in the present invention preferably include carbon, hydrogen and oxygen. The polyols may also include compounds which contain these elements in combination with other elements familiar to those skilled in the art, such as phosphorus, halogen, nitrogen or mixtures thereof. Examples of suitable classes of organic polyol reactants for use in otherwise this invention are polyester polyols and polyether polyols, but they may include polyactone polyols, nitrogen-containing polyols, phosphorus-containing polyols, phenolic-based polyols, and polymer/polyols known in the art.

In one highly preferred embodiment, the polyol is a polyether polyol, a polyester polyol or a mixture thereof. In a still more preferred embodiment, the polyol includes polyester polyol. In one particularly preferred embodiment, it is difunctional aromatic polyester polyol. In one particularly preferred embodiment it is difunctional aromatic polyester polyol. In another it has a hydroxyl value ranging from about 175 to about 315. In yet another, it has a viscosity of about 2500 to about 25000 (cPs, 25° C.). For thin film applications, lower hydroxyl values are possible (e.g., as low as about 110).

The polyol is characterized as having an average molecular weight at room temperature of at least about 700 and preferably ranging from about 1000 to about 8000, and more preferably about 1500 to 3000. Upon heating to about 90° F., the molecular weight will be reduced to a range of about 700 to about 1200. Corunercially available polyols are available from Stepan Company (e.g., under the trade designation Stepanpol®), or ICI America (e.g., under the trade designation 423). An example of one suitable polyol is, without limitation, tearate.

It is well known to the polyurethane art that the particular polyol reactant or combination of polyols employed is a function of the desired end-product. Particular examples of suitable organic polyols useful in the present invention include, without limitation, glycerol, trimethylol propane, butylene glycol, polyalkylene glycols, such as polyethylene glycol, polypropylene glycol, and polybutylene glycol, polyhydroxy polyesters, lactic acid, esters of hydroxy carboxylic acids, such as castor oil, polyhydroxy amino alcohols, such as, N,N,N′,N′-tetrakis-(2-hydroxypropyl) ethylene aliamine, triethanolamine, and the like.

In one embodiment, the starting materials include a noncyclic aliphatic polyactive amine-containing polyol. Preferably, the polyol is reacted with one or more other polyols. By way of example, one preferred starting ingredient is an oxide adduct (e.g. akylene) of a polyactive amine. In another highly preferred embodiment, the ingredient includes a propylene oxide adduct of ethylenediamine. A very specific example without limitation is N, N, N′, N′, -tetralus (2-hydroxypropyl) ethylene-diamine. A commercially available example (having a hydroxyl number of about 767) is marketed by BASF under the designation Quadrol®. Of course, other suitable polyfunctional amines and polyols may also be used.

In one preferred embodiment, where a first polyol is employed in combination with a second polyol, such as, for instance, a noncyclic alphatic polyactive amine-containing polyol, the ratio of the first polyol to the second polyol will range from about 1 to about 0.02 parts by weight.

In a highly preferred embodiment the ratio of polyisocyanate to polyol is about 1 part polyisocyanate to about 1 part polyol, and more preferably about 0.4 polyisocyanate to about 1 part polyol (preferably when employed with a filler). In a highly preferred embodiment, the polyol mixture includes about 75 parts of polyol (e.g., 231 by ICI Americas), about 25 parts sucrose amine (e.g. F180 by ICI Americas), about 0.1% lead octoate (about 36% purity); and up to about 3 parts Quadrol.

### Catalysts

One or more catalysts are used in the process according to the invention. The catalysts used are known and include, by way of example, without limitation, tertiary amines, silamines, bases containing nitrogen, organometallic compounds, or the like.

Examples of nitrogen-containing hydroxides include, for instance, sodium hydroxide, alkali metal phenolates such as sodium phenolate or alkali metal alcoholates such as sodium ethylene. Hexahydrotriazines may also be used as catalysts.

Organic metal compounds may also be used as catalysts according to the invention, especially organic tin compounds. For example, the catalysts may be tin (II) salts of carboxylic acids such as tin (II)-acetate, tin (II) octoate, tin (II)-ethylhexonoate and tin (II)-laurate and the dialkyl tin salts of carboxylic acids such as dibutyl tin diacetate, dibutyl tin dilaurate, dibutyl tin maleate, dibutyl tin oxide, tributyltin methacrylate or dioctyl tin diacetate. iron acetyl acetonate, lead naphthenate, cobalt naphthenate, zinc stearate, sodium stearate, sodium ricinoeate, sodium salicylate, sodium citrate, or the like.

### Blowing Agents

The skilled artisan will appreciate that control over cell size and shape and resulting article density and rigidity characteristics is possible by variation of the type and amount of blowing agent employed. As desired, water, volatile organic substances or both may be used as blowing agents in the process according to the invention. The selection and amount of blowing agent in any particular foam formulation is well within the skill of the cellular polyurethane art. Examples of suitable organic blowing agents include, for instance, butane, hexane, heptane or the like.

A blowing effect can also be obtained by adding compounds, such as those which decompose at temperatures above room temperature to liberate gases. By way of example, such blowing agents may be illustrated by azo-bis-isobutyro-nitrile, sodium carbonate, bicarbonate, or the like.

### Reinforcement

In a highly preferred embodiment, a reinforcement material is used in combination with the starting materials for forming a polyurethane. One example is the use of continuous strand glass fibers (e.g., having a small diameter, such as about 9 μp). Other reinforcements are also possible, including synthetics, carbon or ceramic-based materials. The form of the reinforcement is not critical. Popular forms include without limitation, continuous fiber, chopped fiber, woven, matte, particulated or the like. Moreover, the reinforcement can be provided as a preform (i.e., having a pre-configured shape). Preferably e-glass is used, but a-glass likewise may be employed.

### Filler

Examples of nonreactive powders that can be used as fillers include talc, aluminum, zinc, monoammonium phosphate fatty acids (including tall oil fatty acids or tall oil per se, which, if desired, may be halogenated for example, with chlorine or bromine), vermiculite, saw dust, cork, synthetic plastics including vinyl polymers such as, polyvinyl chloride, polystyrene and the like.

The average particle size of the filler material may vary from about 325 mesh (Tyler) to about 16 mesh (Tyler), with about 200 mesh (Tyler) being an average particle size.

In one highly preferred embodiment, the filler is a particulated by-product of paint sludge that has been reclaimed. By way of example, overspray or excess paint found in an industrial paint spray booth can be collected and separated so that a remaining sediment or sludge by-product is dried by a sludge dryer and particulated into relatively ultrafine or fine particles, e.g., having an average particle size of about 50 mesh. Higher or lower particle sizes may be used. The particles thus will be composed of resinous-based material, such as an acrylic, a urethane, or a mixture thereof, and other residual paint ingredients. In one illustrative embodiment, though not intended do limiting, they typically will have a specific gravity of about 0.590, a moisture content less than about 5% and a maximum particle size (except for about 4.5 percent of the total) being less than or equal to about 850 microns. The present filler also may be employed advantageously in other plastic systems such as without limitation, vinyl esters, polyesters, epoxies or others.

### Other Optional Additives

Other optional additives include one or more or softness control additives, chain extenders, cross-linkers, surfactants, colouring agents (e.g. carbon black, titanium dioxide, methyl blue, chromium red and the like), flame retardants, a conventional mold release or the like.

### Chain Extenders

The softness of the polyurethane foam optionally may be increased by increasing the amount of chain-extenders. Examples of suitable compounds containing active hydrogen (for reacting with isocyanate groups) include compounds containing hydroxyl or amine groups. In particular, examples of suitable chain extenders are water, hydrazine, primary and secondary diamines, amino alcohols, amino acids, hydroxy diols such as ethane diol; butane-1, 2-diol, butane-1, 3-diol, butane-1, 4-diol, hexanediol, diethylene glycol, triethylene glycol, tetraethylene glycol and higher polyglycols preferably having molecular weights in the range 2000 to 3000, ethylene glycol, glycerine, trimethylolpropane, 1,4-butanediol and primary and secondary diamines such as phenylene diamine, 1,4-cyclohexane-bis-(methylamine), ethylenediamine, diethylenetriamine, N-(2-hydroxypropyl) ethylenediamine, N,N′-di(2-hydroxypropyl)ethylenediamine, N,N,N′,N′-tetra(2-hydroxypropyl)ethylenediamine, piperazine, and 2-methylpiperazine, acids, glycols, or mixtures thereof.

### Cross-Linkers

The hardness of polyurethane foam optionally may be increased by increasing the amount of cross-linkers. In this specification cross-linkers preferably are compounds containing more than 2 active hydrogen atoms per molecule, preferably more than 3. Examples of such cross-linkers are diethanolamine, triethanolamine, N,N,N′,N′-tetrakis-(2-hydroxypropyl)ethylene diamine, and phenol/formaldehyde/aniline condensation products.

It is possible to use a cross-linker in the polyol formulation giving softer foam, provided that the formulation giving harder foam contains an increased quantity of cross linker and/or contains an isocyanate giving a harder foam. Similarly it is possible to use a chain extender in the polyol giving a harder foam if the formulation giving softer foam contains an increased quantity of chain extender or an isocyanate giving softer foam.

### Surfactant

A surface-active agent may be desirable for production of high grade molded polyurethane foam according to the present invention, to help the foams so they do not collapse or contain very large uneven cells. While other surfactants may be employed, nonionic surface active agents (e.g. silicones) are preferred.

### Flame Retardant

Included as examples, among the flame retardants which optionally may be employed in any suitable amount are pentabromodiphenyl oxide, antimony oxide, dibromopropanol, tris (-chloropropyl)phosphate, 2,2-bis(bromoethyl) 1,3-propanediol, tetrakis(2-chloroethyl) ethylene diphosphate, tris(2,3-dibromopropyl)phosphate, tris (-chloroethyl)-phoshate, tris(1,2-dichloropropyl)phosphate, bis-(2-chloro-ethyl) 2-chloroethylphosphonate, molybdenum trioxide, ammonium molybdate, ammonium phosphate, pentabromodiphenyloxide, tricresyl phosphate, triphenyl phosphate, hexabromocyclododecane and dibromoethyl-dibromocyclohexane.

### Water

The cell structure is obtained by the interaction of any blowing agent, preferably water, which interacts with the prepolymers to produce carbon dioxide gas. If desired, the water added may be added as a separate component, or it can at least in part comprise water added in conjunction with another component of the system. The person skilled in the art will be able to readily select the amount of water depending upon the desired result.

### Processing

To prepare composition and articles according to the system and process of the present invention, the materials may be prepared either by a single step process or a two-step process. In summary, in the single-step process, the preparation of the prepolymer of the two-step process is omitted and all of the reactive active hydrogen compounds are combined essentially simultaneously with the polyisocyanate. Additives can be added to the individual reactive components prior to or during the final mixing step.

The two-step process consists of first preparing a polyurethane prepolymer having free isocyanate groups by reacting an excess of a polyisocyanate, with a high molecular weight polyol. All or a portion of the additives may be added to the prepolymer or their remaining portions may be added later-together with a chain extender. In the second step, the chain extender (when used), is mixed into the prepolymer. The catalyst, if employed, may also be added to the prepolymer but preferably to the chain extender component. The ingredients are combined in a mixer. Mixing is continued at any suitable pressure for any suitable time to assure a substantially homogenous mixture. The mixture is then placed into a mold and cured.

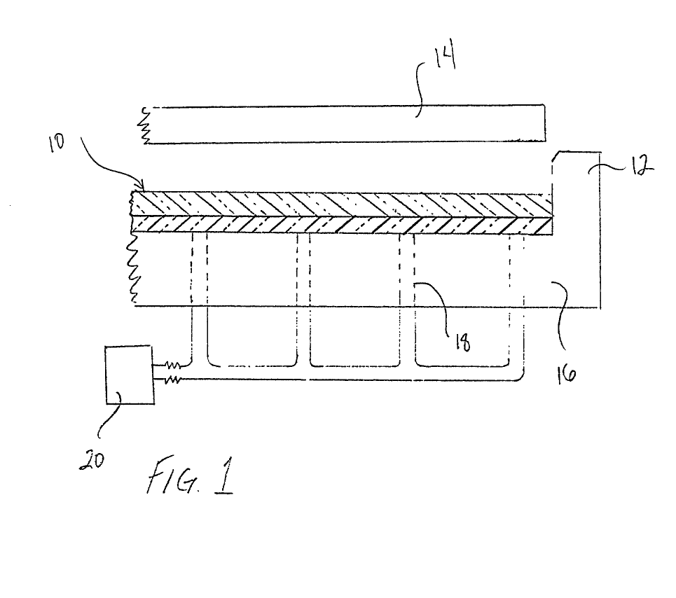

Referring to FIG. 1, in one preferred embodiment, an article 10 is prepared by providing a mold 12 having a cavity generally defining the shape of the desired article. Resin and reinforcement is introduced into the cavity. Particularly when a laminate article is manufactured with vacuum assistance, though no vacuum may suitably be employed. Thus, the mold includes platens 14 and 16 having one or more channels 18, associated with a vacuum source 20, defined therein to help create a negative pressure in the mold cavity when a vacuum is employed. The platens preferably are maintained at an elevated temperature (e.g. about 120° F. to about 140° F. and more preferably about 130° F.; as desired, depending on the ultimate application, higher or lower temperatures are used). The cavity is closed and one or more pressures are applied as needed to maintain the desired interior dimensions of the cavity. It should be noted that temperature, pressure or both can be applied to the material in the mold cavity to vary the density at preselected locations across its section. In one embodiment, where a laminate is made having a molded polyurethane bonded to a sheet of acoustical foam material, a vacuum is applied to draw the acoustical foam material securely against the platen (to help avoid wrinkles). A suitable pressure is applied to the polyurethane reactants while the mixture is reacting to help assure the mold remains shut and the desired article density is achieved. Further layers can be added to the article by adding additional material to at least a partially reacted article or by removing at least partially the reacted article and placing such additional material in the mold cavity, turning the at least partially reacted article over and again placing it in the mold cavity for processing as discussed in the above.

As the skilled artisan will appreciate, numerous variations to the desired end product are possible according to the present process, including but not limited to monolithic parts having variations in thickness or densities. Laminates are also possible. For instance, one or more polyurethanes may be bonded to one or more layers of high pressure laminate (e.g. melamine) sheet, a second foam, wood, metal, plastic, fiber based material, paperboard, cork, textiles or other dissimilar material. In this manner, laminates may be made, such as (without limitation), a combination of a first layer and a second layer; such as first material/polyurethane, first material/polyurethane/first material, first material/polyurethane/second material, polyurethane/first material/polyurethane, polyurethane/first material/polyurethane/second material, etc. Illustrating by reference to particular examples of materials for example, “sandwich” laminate combinations can be made such as acoustic foam/polyurethane/ high pressure laminate (e.g. melamine); high pressure laminate (e.g. melamine)/polyurethane/ high pressure laminate (e.g. melamine); acoustic foam/polyurethane/acoustic foam; polyurethane/acoustic foam/polyurethane. Laminate or other surfaces may be employed on either or both sides of the outer “sandwich” layers. It is recognized that polyurethane as used in the above description encompasses the preferred reinforced polyurethane foam of the present invention. Though not imperative to fall within the present invention, one of the advantageous features of the invention is that it permits a high integrity bond to form between layers of materials having dissimilar properties or characteristics. The bond primarily is a mechanical bond with potentially incidental chemical bonding. Without intending to be bound by theory, it is believed that reactants from the polyurethane system penetrate porous surfaces of opposing layers and upon curing will effectively form an “anchor” along with any incidental chemical bond.

In one particularly preferred embodiment, the first layer is a glass-reinforced polyurethane in accordance with the present invention. Such first layer is bonded to a second layer that is a second polyurethane foam, which may be lower density than the first layer (e.g., in a ratio of about 1 to about 5:1 density ratio between the first polyurethane and the second polyurethane). Without limitation, an example of one such material is Rubinate™ IV-1 available through CGR or Hutsman ICI Chemicals, LLC. An example of a suitable density range for the material is about 3 to about 10 pounds per cubic foot (pcf). Such material is an open cell foam, but a closed cell foam can also be employed. In another embodiment, the density of the second layer is higher than the first.

Compression molding techniques may be suitably employed also. It will be appreciated also that the invention is not limited to molded articles. Articles may be prepared from any of a number of processes such as hand lay-up, spray techniques, cast in place, or the like. One or more layers of polyurethane sheet stock may also be employed and bonded to another layer of material.

Resulting articles from the present invention find utility in a number of applications, including but not limited to building panels such as ceiling tiles, wallboard, ornamental paneling, insulation panels, acoustic panels, boat hulls, flooring, transport vehicle structural materials, cabinetry, instrumentation housings, or the like.

Although the invention has been described with particular reference to certain preferred embodiments thereof, variations and modifications can be effected within the spirit and scope of the following claims.

What is claimed is:

1. A polyurethane composition, comprising
a. the reaction product of:
i. a polyol
ii. a polyisocyante
b. reinforcement material; and
c. a filler including reclaimed paint sediment.

2. A composition according to claim 1, wherein said reinforcement material is glass fibre.

3. A composition according to claim 1, wherein said filler includes a plurality of particles of reclaimed paint sediment.

4. A composition according to claim 1, wherein said reclaimed paint sediment portion of said filler includes having a majority of particles with a particle size less than or equal to about 850 microns.

5. A composition according to claim 1, wherein said reclaimed paint sediment is from a polyurethane paint system.

6. A composition according to claim 1, wherein said reclaimed paint sediment is from an acrylic paint system.

7. A composition according to claim 1, wherein said polyol includes a noncyclic aliphatic polyactive amine.

8. A composition according to claim 1, wherein said polyol includes a propylene oxide adduct of ethylenediamine.

9. A composition according to claim 8, wherein said polyol is a polyester polyol.

10. A composition according to claim 9, wherein said polyisocyanate is an aromatic diisocyanate.

11. An article comprising:
a. a first material; and
b. a polyurethane foam mechanically bonded directly to said first material over at least a portion of its surface.

12. An article according to claim 11, wherein said first material is an acoustic foam.

13. An article according to claim 12, wherein said acoustic foam has a density of about 0.20 to about one times the density of said polyurethane foam.

14. An article according to claim 11, further comprising a chemical bond between said polyurethane foam and said first material over at least a portion of said first material.

15. An article according to claim 14, wherein said polyurethane foam is based upon a polyester polyol and said first material is a polyurethane acoustic foam based upon a polyester polyol.

16. An article according to claim 11, wherein said polyurethane foam includes a filler having reclaimed paid sediment particles dispersed therein.

17. An article according to claim 11, wherein said polyurethane foam is prepared using an oxide adduct of a polyactive amine.

18. An article according to claim 11, wherein said first material is a 20 foam having a density of about 3 to about 10 pcf;
said polyurethane foam has a density of about 5 to about 50 pcf;
said article has a compressive strength of at least about 20 ksi.

19. A method for making a polyurethane containing article comprising the steps of:
a. reacting
i. a polyol admixture including an oxide adduct of a polyactive amine; and
ii. a polyisocyante;
b. placing a first layer of material in a mold cavity;
c. vacuum drawing said first layer against a platen;
d. mechanically bonding said first layer to the reaction product of said step (a).

20. A method according to claim 19, further comprising reacting a noncyclic aliphatic polyactive amine with a polyester polyol and said polyisocyanate, and incorporating therein a filler including reclaimed paint sediment.
